(19) United States
(12) Patent Application Publication
(10) Pub. No.: US 2010/0220094 A1
(43) Pub. Date: Sep. 2, 2010

(54) SCAN SIGNAL LINE DRIVER CIRCUIT AND DISPLAY DEVICE

(76) Inventor: Toshio Watanabe, Osaka (JP)

Correspondence Address: HARNESS, DICKEY & PIERCE, P.L.C., P.O. BOX 8910, RESTON, VA, 20195, US

(21) Appl. No.: 12/734,220

(22) PCT Filed: Oct. 14, 2008
(86) PCT No.: PCT/JP2008/068545

§ 371 Date: Apr. 19, 2010

(30) Foreign Application Priority Data
Oct. 26, 2007 (JP) 2007-279670

(51) Int. Cl. G06F 3/038

(52) U.S. Cl. 345/213

(57) ABSTRACT

In one embodiment of the present invention, in order to achieve a scan signal line driver circuit that is highly resistant to noise that causes a change in level toward High and therefore unlikely to suffer from a display problem, a gate driver of the present invention that is provided in a TFT liquid crystal panel includes a shift register having D-FFs connected in cascade, and signals are outputted through the respective data output terminals of the D-FFs. Because the D-FFs have their respective data output terminals connected to pull-down resistors, a change in level of the signals from the respective data output terminals of the D-FFs can be prevented even when noise that causes a change in level toward High is received. This makes it possible to prevent the occurrence of such a display problem that a gate line that is not supposed to carry out a display is accidentally turned on by noise that causes a change in level toward High.

### TECHNICAL FIELD

The present invention relates to a signal scanning line driver circuit that feeds scanning signals into scan signal lines of a display screen and a display device in which such a scan signal line driver circuit is used.

### BACKGROUND ART

In recent years, there has come to be accessibility to a large number of radio sources such as electronic devices, electric devices, and wireless devices. Electromagnetic waves from such radio sources may exert various influences on the surrounding electromagnetic environment, and electronic devices and the like that radiate electromagnetic waves may also be influenced by electromagnetic waves radiating from other radio sources. For this reason, electronic devices and the like need to keep in electromagnetic wave and to be made resistant to the surrounding electromagnetic environment.

There have been standards set for evaluation of such electronic devices and the like in relation to electromagnetic waves and, in particular, there is a standard called IEC61000-4-2, which is a standard for electrostatic discharge simulation. A test conforming to the IEC61000-4-2 standard is conducted by use of a pulse generating device called an ESD gun. On display devices such as liquid crystal displays, too, a test to determine the presence or absence of influences on displays is conducted through an electrostatic discharge simulation by the ESD gun as stated above.

Further, there has been proposed a technology for improving the resistance of electronic devices and the like to electromagnetic waves (e.g., Patent Literature 1).

FIG. 12 shows the configuration of a semiconductor chip 91 described in Patent Literature 1. Provided in a peripheral portion of the semiconductor chip 91 are a plurality of peripheral pads 92 connected to the outside through wires 93. Furthermore, there are a plurality of central pads 94 provided uniformly on a chip surface of the semiconductor chip 91, but not on the peripheral pads 92, in a linear and reticular pattern. The central pads 94 are connected continuously to one another through wires 95 by wire bonding.

Such a configuration makes it possible to diminish a voltage drop that occurs due to wiring resistance, reduce the potential gradient of each wire, and therefore prevent a malfunction or the like from occurring due to noise from the power supply.

### CITATION LIST

Patent Literature 1

Japanese Patent Application Publication, Tokukai, No. 2005-85829 A (Publication Date: Mar. 31, 2005)

### SUMMARY OF INVENTION

However, although the conventional configuration has somewhat improved resistance to noise that causes a change in level toward Low, it is prone to malfunction in response to noise that causes a change in level toward High. In particular, a display device such as a TFT liquid crystal panel may suffer from such a display problem as the occurrence of a horizontal bright line when an unintended gate line is turned on by noise that causes a change in level toward High. The following explains this problem in concrete terms.

FIG. 13 is a schematic view showing the structure of a conventionally typical TFT liquid crystal panel 101. The TFT liquid crystal panel 101 includes a glass substrate 102, source drivers 103, and gate drivers 104. The glass substrate 102 has TFTs 107 provided thereon, and each of the TFTs 107 has its drain connected to a pixel 108 obtained by interposing liquid crystals between pixel electrodes. Further, each of the TFTs 107 has its source connected to a source line 105 leading to the driving output of its corresponding source driver 103. Each of the TFTs 107 has its gate connected to a gate line 106 leading to the driving output of its corresponding gate driver 104.

Each of the TFTs 107 is turned on when its gate is supplied with a signal from its corresponding gate line 106, and its corresponding pixel 108 is supplied with a signal from its corresponding source line 105. The signal supplied to the pixel 108 is stored in the pixel 108 as a voltage between the pixel 108 and a counter electrode 109, and in accordance with this voltage, the transmission level of the liquid crystals in the pixel 108 is determined. Thus, a display is carried out.

FIG. 14 is a circuit diagram showing the structure of each of the gate drivers 104. Each of the gate drivers 104 includes a shift register 110, level-shifter circuits 112, output buffers 113, and output terminals 114. The shift register 110 is constituted by seven D-FFs (D flip-flops) 111, and signals from the outputs Q1 to Q7 of the D-FFs 111 are inputted to the level-shifter circuits 112, respectively, and then subjected to level conversion. Signals from the level-shifter circuits 112 are outputted from the output terminals 113 to the gate line 106 through the output buffers 112, respectively.

In the shift register 110, the D-FFs 111 are actuated by an actuating clock CLK, and a signal inputted from an input IN is outputted to Q1 to Q7 sequentially in synchronization with the actuating clock CLK. Each of the gate drivers 104 is mounted so that a single output corresponds to a single gate line 106, and the gate lines 106 are driven sequentially so that the TFT liquid crystal panel 101 carries out a display.

The outputs Q1 to Q7 of the shift register 110 are usually Low. A High pulse is inputted to the input IN in synchronization with the start of a display and shifted to be a sequence of High pulses. The High pulses shifted in the shift register 110 make the gate line 106 High sequentially to turn on the TFTs 107, whereby a screen display is carried out.

It should be noted here that semiconductor integrated circuits such as the gate drivers 104 are supplied with power from power supply terminal pads located therearound. As described in the Background Art section of Patent Literature 1, recent trends toward finer processing and larger chip size have led to an unignorably large increase in resistance of power supply wires from power supply terminal pads to the active region inside of a chip, and such an increase causes a malfunction to occur due to noise from the power supply. Such wiring resistance exerts an influence on signal wires as well as the power supply.

Specifically, when the electrostatic discharge simulation test described above in the Background Art section was conducted on such TFT liquid crystal display panels 101 as shown in FIG. 13, some of the TFT liquid crystal display panels 101 suffered from such a defect as the appearance of a horizontal bright line in the display screen. The cause of this display problem was analyzed, whereby it was found that the horizontal bright line occurred in the display because an unintended gate line 106 was turned on by a change in level caused at the outputs of the D-FFs 111 and the input sides of the output buffers 113 in the gate driver 104 by noise that causes a change in level toward High.

As stated above, when noise causes each output of the shift register 110 to change in level toward High and the output of the gate driver 104 becomes High at a timing other than a timing when High pulses are supposed to be outputted, a gate line 106 that is not supposed to carry out a display is accidentally turned on to cause a display problem.

Alternatively, when noise causes some of the outputs of the D-FFs 111 to become High and the inputs of the next D-FFs 111 take in this High level, the shift register 110 comes to shift High pulses caused by the noise, in addition to High pulses that are shifted in a normal way, with the result that a display problem ensues.

Thus, resistance to noise that causes a change in level toward High cannot be improved by reducing a voltage drop that occurs due to wiring resistance as in the configuration described in Patent Literature 1.

The present invention has been made in view of the foregoing problems, and it is an object of the present invention to provide a scan signal line driver circuit and a display device that are highly resistant to noise that causes a change in level toward High and therefore unlikely to suffer from a display problem.

In order to solve the foregoing problems, a scan signal line driver circuit according to the present invention includes a first shift register having M (where M is an integer of 2 or greater) flip-flops connected in cascade, the first shift register receiving an input signal from outside, transferring the input signal to the subsequent flip-flops sequentially in synchronization with a clock signal, outputting first shift pulses through respective data output terminals of the flip-flops, thereby driving a scan signal line of a display screen, at least one of the flip-flops having its data output terminal connected to a pull-down resistor.

According to the foregoing configuration, the M flip-flops of the first shift register transfer the input signal sequentially and thereby output the first shift pulses for driving the scan signal line. It should be noted here that the pull-down resistor, connected to the data output terminal of the at least one flip-flop, functions to cancel a change in level of the first shift pulses toward High in response to external noise that causes a change in level toward High. This makes it possible to prevent the occurrence of such a display problem that a gate line that is not supposed to carry out a display is accidentally turned on because the first shift pulses become High at an unintended timing. This brings about an effect of achieving a scan signal line driver circuit that is highly resistant to noise that causes a change in level toward High and therefore unlikely to suffer from a display problem.

The scan signal line driver circuit according to the present invention is preferably configured to further include: a second shift register having M flip-flops connected in cascade; and M logic circuits, wherein: the second shift register transfers an inverted version of the input signal to the subsequent flip-flops sequentially in synchronization with the clock signal and outputs second shift pulses through respective data output terminals of the flip-flops; at least one of the flip-flops of the second shift register having its data output terminal connected to a pull-up resistor; each of the logic circuits outputs a logical sum of a first shift pulse from the Nth (where N is an integer of 1 to M) flip-flop of the first shift register and an inverted version of a second shift pulse from the Nth flip-flop of the second shift register as a third shift pulse; and the third shift pulses allow the scan signal line to be driven.

According the foregoing configuration, the second shift register is further provided in addition to the first shift register. The flip-flops constituting the second shift register, as opposed to the first shift register, transfer the inverted version of the input signal sequentially and output the second shift pulses. It should be noted here that the pull-up resistor, connected to the data output terminal of the at least one flip-flop of the second shift register, functions to cancel a change in level of the second shift pulses toward Low in response to external noise that causes a change in level toward Low.

Furthermore, each of the logic circuits works out a logical sum of a first shift pulse from its corresponding flip-flop of the first shift register and an inverted version of a second shift pulse from the counterpart flip-flop of the second shift register, and outputs the logical sum as a third shift pulse to drive the scan signal line. Thus, even when noise that causes a change in level toward Low stops the first shift register from shifting and therefore causes the first shift pulses to disappear, the inverted versions of the second shift pulses are outputted as the third shift pulses. It should be noted here that because the second shift pulses are outputted by shifting the inverted version of the input signal, the inverted versions of the second shift pulses are identical in waveform to the first shift pulses as normally shifted. Therefore, even when noise that causes a change in level toward Low causes the first shift pulses to disappear, the third shift pulses are still identical in waveform to the first shift pulses as normally shifted, unless the second shift pulses disappear.

As stated above, since the second shift pulses are unlikely to change in level in response to noise that causes a change in level toward Low, the third shift pulses are unlikely to change in level not only in response to noise that causes a change in level toward High, but also in response to noise that causes a change in level toward Low. Therefore, a scan signal line driver circuit that is highly resistant to both noise that causes a change in level toward High and noise that causes a change in level toward Low can be achieved.

In order to solve the foregoing problems, a scan signal line driver circuit according to the present invention includes a first shift register having M (where M is an integer of 2 or greater) flip-flops connected in cascade, the first shift register receiving an input signal from outside, transferring the input signal to the subsequent flip-flops sequentially in synchronization with a clock signal, outputting first shift pulses through respective data output terminals of the flip-flops, thereby driving a scan signal line of a display screen, at least one of the flip-flops including a first transfer gate constituting a data input terminal of the at least one flip-flop, a first inverter, a second transfer gate, a second inverter, and a first buffer circuit constituting a data output terminal of the at least one flip-flop, the data input terminal, the first transfer gate, the first inverter, the second transfer gate, the second inverter, and the first buffer circuit being connected in this order, a first pull-up resistor being provided at a first connection point between the first inverter and the second transfer gate, a first pull-down resistor being provided at a second connection point between the second inverter and the first buffer circuit.

According to the foregoing configuration, the M flip-flops of the first shift register transfer the input signal sequentially and thereby output the first shift pulses for driving the scan signal line. It should be noted here that since the at least one flip-flop has the first pull-up resistor provided at the first connection point between the first inverter and the second transfer gate, and the first pull-down resistor at the second connection point between the second inverter and the first buffer circuit, the internal resistance of the flip-flop to noise that causes a change in level toward High can be enhanced. Therefore, the first shift pulses are unlikely to change in level even in response to noise that causes a change in level toward High. This makes it possible to prevent the occurrence of such a display problem that a gate line that is not supposed to carry out a display is accidentally turned on because the first shift pulses become High at an unintended timing. This brings about an effect of achieving a scan signal line driver circuit that is highly resistant to noise that causes a change in level toward High and therefore unlikely to suffer from a display problem.

The scan signal line driver circuit according to the present invention may be configured such that: the first pull-up resistor is provided at a third connection point between the second transfer gate and the second inverter instead of being provided at the first connection point; and the first pull-down resistor is provided at a fourth connection point between the first transfer gate and the first inverter instead of being provided at the second connection point.

According to the foregoing configuration, the first pull-up resistor is provided at the third connection point between the second transfer gate and the second inverter, and the first pull-down resistor is provided at the fourth connection point between the first transfer gate and the first inverter; therefore, the internal resistance of the flip-flop to noise that causes a change in level toward High can be enhanced. Therefore, the first shift pulses are unlikely to change in level even in response to noise that causes a change in level toward High.

The scan signal line driver circuit according to the present invention may be configured such that: the first inverter is constituted by a first transistor that outputs a high-level signal and a second transistor that outputs a low-level signal; the second inverter is constituted by a third transistor that outputs a high-level signal and a fourth transistor that outputs a low-level signal; and instead of providing the first pull-up resistor and the first pull-down resistor, the first transistor is set higher in driving capacity than the second transistor and the fourth transistor is set higher in driving capacity than the third transistor.

According to the foregoing configuration, the first transistor, which outputs a high-level signal, of the first inverter is higher in driving capacity than the second transistor, which outputs a low-level signal, of the first inverter, the situation is the same as in the case where the pull-up resistor is provided at the first connection point between the first inverter and the second transfer gate. Further, the fourth transistor, which outputs a low-level signal, of the second inverter is higher in driving capacity than the third transistor, which outputs a high-level signal, of the second inverter, the situation is the same as in the case where the pull-down resistor is provided at the second connection point between the second inverter and the first buffer circuit. Therefore, the internal resistance of the flip-flop to noise that causes a change in level toward High can be enhanced, and such a configuration is possible that the first shift pulses are unlikely to change in level even in response to noise that causes a change in level toward High.

The scan signal line driver circuit according to the present invention is preferably configured to further include: a second shift register having M flip-flops connected in cascade; and M logic circuits, wherein: the second shift register transfers an inverted version of the input signal to the subsequent flip-flops sequentially in synchronization with the clock signal and outputs second shift pulses through respective data output terminals of the flip-flops; at least one of the flip-flops of the second shift register includes a third transfer gate constituting a data input terminal of the at least one flip-flop, a third inverter, a fourth transfer gate, a fourth inverter, and a second buffer circuit constituting a data output terminal of the at least one flip-flop, the data input terminal, the third transfer gate, the third inverter, the fourth transfer gate, the fourth inverter, and the second buffer circuit being connected in this order; a second pull-down resistor is provided at a fifth connection point between the third inverter and the fourth transfer gate, a second pull-up resistor is provided at a sixth connection point between the fourth inverter and the second buffer circuit; each of the logic circuits outputs a logical sum of a first shift pulse from the Nth (where N is an integer of 1 to M) flip-flop of the first shift register and an inverted version of a second shift pulse from the Nth flip-flop of the second shift register as a third shift pulse; and the third shift pulses allow the scan signal line to be driven.

According the foregoing configuration, the second shift register is further provided in addition to the first shift register. The flip-flops constituting the second shift register, as opposed to the first shift register, transfer the inverted version of the input signal sequentially and output the second shift pulses. It should be noted here that since the at least one flip-flop of the second shift register has the second pull-down resistor provided at the fifth connection point between the third inverter and the fourth transfer gate, and the second pull-up resistor at the sixth connection point between the fourth inverter and the second buffer circuit, the internal resistance of the flip-flop to noise that causes a change in level toward Low can be enhanced. Therefore, the second shift pulses are unlikely to change in level even in response to noise that causes a change in level toward Low.

Furthermore, each of the logic circuits works out a logical sum of a first shift pulse from its corresponding flip-flop of the first shift register and an inverted version of a second shift pulse from the counterpart flip-flop of the second shift register, and outputs the logical sum as a third shift pulse to drive the scan signal line. Thus, even when noise that causes a change in level toward Low stops the first shift register from shifting and therefore causes the first shift pulses to disappear, the inverted versions of the second shift pulses are outputted as the third shift pulses. It should be noted here that because the second shift pulses are outputted by shifting the inverted version of the input signal, the inverted versions of the second shift pulses are identical in waveform to the first shift pulses as normally shifted. Therefore, even when noise that causes a change in level toward Low causes the first shift pulses to disappear, the third shift pulses are still identical in waveform to the first shift pulses as normally shifted, unless the second shift pulses disappear.

As stated above, since the second shift pulses are unlikely to change in level in response to noise that causes a change in level toward Low, the third shift pulses are unlikely to change in level not only in response to noise that causes a change in level toward High, but also in response to noise that causes a change in level toward Low. Therefore, a scan signal line driver circuit that is highly resistant to both noise that causes a change in level toward High and noise that causes a change in level toward Low can be achieved.

The scan signal line driver circuit according to the present invention may be configured such that: the second pull-down resistor is provided at a seventh connection point between the fourth transfer gate and the fourth inverter instead of being provided at the fifth connection point; and the second pull-up resistor is provided at an eighth connection point between the third transfer gate and the third inverter instead of being provided at the sixth connection point.

According to the foregoing configuration, the second pull-down resistor is provided at the seventh connection point between the fourth transfer gate and the fourth inverter, and the second pull-up resistor is provided at the eighth connection point between the third transfer gate and the third inverter; therefore, the internal resistance of the flip-flop to noise that causes a change in level toward Low can be enhanced. Therefore, the second shift pulses are unlikely to change in level even in response to noise that causes a change in level toward Low.

The scan signal line driver circuit according to the present invention may be configured such that: the third inverter is constituted by a fifth transistor that outputs a high-level signal and a sixth transistor that outputs a low-level signal; the fourth inverter is constituted by a seventh transistor that outputs a high-level signal and an eighth transistor that outputs a low-level signal; and instead of providing the second pull-up resistor and the second pull-down resistor, the sixth transistor is set higher in driving capacity than the fifth transistor and the seventh transistor is set higher in driving capacity than the eighth transistor.

According to the foregoing configuration, the sixth transistor, which outputs a low-level signal, of the third inverter is higher in driving capacity than the fifth transistor, which outputs a high-level signal, of the third inverter, the situation is the same as in the case where the pull-down resistor is provided at the fifth connection point between the third inverter and the fourth transfer gate. Further, the seventh transistor, which outputs a high-level signal, of the fourth inverter is higher in driving capacity than the eighth transistor, which outputs a low-level signal, of the fourth inverter, the situation is the same as in the case where the pull-up resistor is provided at the sixth connection point between the fourth inverter and the second buffer circuit. Therefore, the internal resistance of the flip-flop to noise that causes a change in level toward Low can be enhanced, and such a configuration is possible that the second shift pulses are unlikely to change in level even in response to noise that causes a change in level toward Low.

In order to solve the foregoing problems, a scan signal line driver circuit according to the present invention includes: at least one first shift register having M (where M is an integer of 2 or greater) flip-flops connected in cascade; at least one second shift register having M flip-flops connected in cascade; and M majority circuits, the total sum of the number of the at least one first shift register and the number of the at least one second shift register being three or a larger odd number, the at least one first shift register receiving an input signal from outside, transferring the input signal to the subsequent flip-flops sequentially in synchronization with a clock signal, outputting first shift pulses through respective data output terminals of the flip-flops of the at least one first shift register, at least one of the flip-flops of the at least one first shift register having its data output terminal connected to a pull-down resistor, the at least one second shift register transferring an inverted version of the input signal to the subsequent flip-flops sequentially in synchronization with the clock signal and outputting second shift pulses through respective data output terminals of the flip-flops of the at least one second shift register, at least one of the flip-flops of the at least one second shift register having its data output terminal connected to a pull-up resistor, each of the majority circuits receiving a first shift pulse from the Nth (where N is an integer of 1 to M) flip-flop of the at least one first shift register and an inverted version of a second shift pulse from the Nth flip-flop of the at least one second shift register, the majority circuit choosing pulses that form a majority among the pulses thus received and outputting, as a third shift pulse, the pulses thus chosen, the third shift pulses allowing a scan signal line of a display screen to be driven.

According to the foregoing configuration, a total of three first and second shift registers or a larger odd number of first and second shift registers are provided. It should be noted here that as state above, the pull-down resistor allows the first shift register to be highly resistant to noise that causes a change in level toward High, and the pull-up resistor allows the second shift register to be highly resistant to noise that causes a change in level toward Low.

Furthermore, each of the majority circuits receives a first shift pulse from its corresponding flip-flop of the at least one first shift register and an inverted version of a second shift pulse from the counterpart flip-flop of the at least one second shift register, chooses pulses that form a majority among the pulses thus received, and outputs, as a third shift pulse, the pulses thus chosen. When all of the shift registers are in normal shift operation, the first shift pulses and the inverted version of the second shift pulses are identical in waveform. It should be noted here that even when external noise that causes a change in level toward High or Low causes errors in some of the shift pulses and therefore some of the input pulses become different in waveform from the other input pulses, the third shift pulses are the same as those normally shifted, because each of the majority circuits chooses pulses that form a majority. Therefore, a scan signal line driver circuit that is highly resistant to both noise that causes a change in level toward High and noise that causes a change in level toward Low can be achieved.

The scan signal line driver circuit according to the present invention is preferable configured such that when the at least one first or second shift register comprises a plurality of first or second shift registers, the plurality of first or second shift registers are not located close to each other and do not share a power supply wire or a GND wire with each other.

The first shift registers are high in resistance to noise that causes a change in level toward High, but are low in resistance to noise that causes a change in level toward Low. Further, the second shift registers are high in resistance to noise that causes a change in level toward Low, but are low in resistance to noise that causes a change in level toward High. Therefore, for example, when the first shift registers are larger in number than the second shift registers and noise that causes a change in level toward Low causes errors in all of the first shift registers, the third shift pulses from the majority circuits become errors, too.

As opposed to this, according to the foregoing configuration, the first or second shift registers are not located close to each other and do not share a power supply wire or a GND wire with each other. This makes it possible to reduce the risk that noise that causes a change in level toward High or Low causes errors in all of either the first or second shift registers. Therefore, the influence of noise on the third shift pulses can be further reduced.

A display device according to the present invention include such a scan signal line driver circuit as described above.

According to the foregoing configuration, the scan signal line driver circuit is highly resistant to both noise that causes a change in level toward High and noise that causes a change in level toward Low, thus bringing about an effect of achieving a display device that is unlike to suffer from a display problem.

As described above, a scan signal line driver circuit according to the present invention is configured such that at least one of the flip-flops has its data output terminal connected to a pull-down resistor, thus bringing about an effect of realizing a scan signal line driver circuit that is highly resistant to noise that causes a change in level toward High and therefore unlikely to suffer from a display problem.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a circuit diagram showing the configuration of a gate driver according to Embodiment 1.

FIG. 2 is a schematic view showing the configuration of a TFT liquid crystal panel according to Embodiment 1.

FIG. 3 is a circuit diagram showing the configuration of a gate driver according to Embodiment 2.

FIG. 4 is a timing chart showing the waveforms of signals from flip-flops and OR circuits at normal times when the gate driver of FIG. 3 is not receiving any noise.

FIG. 5 is a timing chart showing the waveforms of signals from flip-flops and OR circuits when the gate driver of FIG. 3 receives noise that causes a change in level toward Low.

FIG. 6 is a circuit diagram showing a modification of a logic circuit according to the present invention.

FIG. 7 is a circuit diagram showing the configuration of a gate driver according to Embodiment 3.

FIG. 8 is a circuit diagram detailing each flip-flop constituting one of the shift registers in the gate driver of FIG. 7.

FIG. 9 is a circuit diagram detailing each flip-flow constituting the other shift register in the gate driver of FIG. 7.

FIG. 10 is a circuit diagram showing the configuration of a gate driver according to Embodiment 4.

FIG. 11 is a circuit diagram detailing a majority circuit that is provided in the gate driver of FIG. 10.

FIG. 12 is a schematic view showing the configuration of a conventional semiconductor chip.

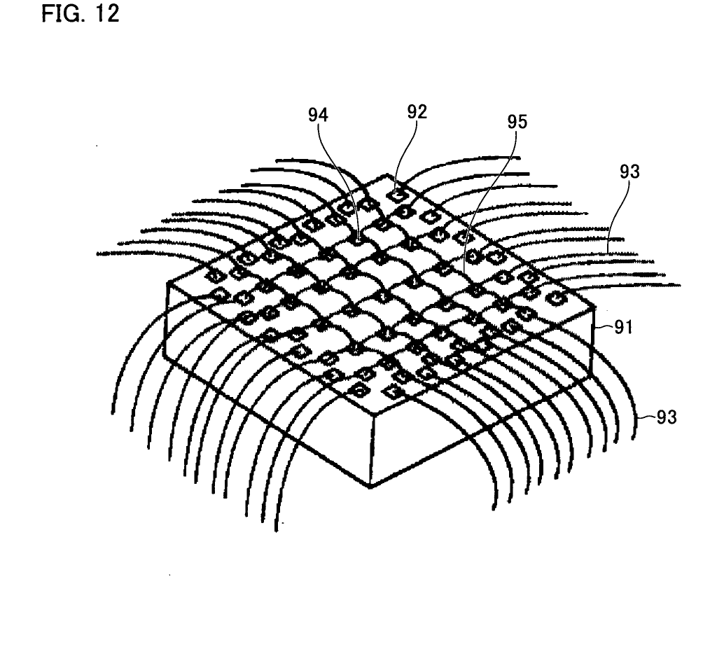

FIG. 13 is a schematic view showing the configuration of a conventional TFT liquid crystal panel.

FIG. 14 is a circuit diagram showing the configuration of a conventional gate driver.

### REFERENCE SIGNS LIST

1 TFT liquid crystal panel (display device)
4, 24, 34, 44 Gate driver (scan signal line driver circuit)
6 Gate line (scan signal line)
10d, 10e Shift register (first shift register)
10u Shift register (second shift register)
10d, 10u, 10e Shift register
11 D-FF (flip-flop)
12 Level-shifter circuit
15 OR circuit (logic circuit)
16 AND circuit (logic circuit)
25 Majority circuit
30d Shift register (first shift register)
30u Shift register (second shift register)
31d, 31u D-FF (flip-flop)
BUFF Buffer (first buffer circuit, second buffer circuit)
CLK Actuating clock (clock signal)
D Data input terminal
IN Input signal
N2 Transistor (second transistor, sixth transistor)
N4 Transistor (fourth transistor, eighth transistor)
P2 Transistor (first transistor, fifth transistor)
P4 Transistor (third transistor, seventh transistor)
Q Data output terminal.
Q1 to Q7 Signals (third shift pulses)
Q1d to Q7d Signals (first shift pulses)
Q1u to Q7u Signals (second shift pulses)
Q1e to Q7e Signals (first shift pulses)
Q11d to Q17d Signals (first shift pulses)
Q11u to Q17u Signals (second shift pulses)
Rd Pull-down resistor
Rd 1 Pull-down resistor (first pull-down resistor)
Rd2 Pull-down resistor (second pull-down resistor)
Ru Pull-up resistor
Ru 1 Pull-up resistor (first pull-up resistor)
Ru2 Pull-up resistor (second pull-up resistor)
a point (fourth connection point, eighth connection point)
b point (first connection point, fifth connection point)
c point (third connection point, seventh connection point)
d point (second connection point, sixth connection point)

### DESCRIPTION OF EMBODIMENTS

In the following, embodiments of semiconductor devices according to the present invention are described with reference to the drawings. In the description below, various limitations technically preferred for carrying out the present invention are added; however, the present invention is not limited in scope to the embodiments and drawings below.

### Embodiment 1

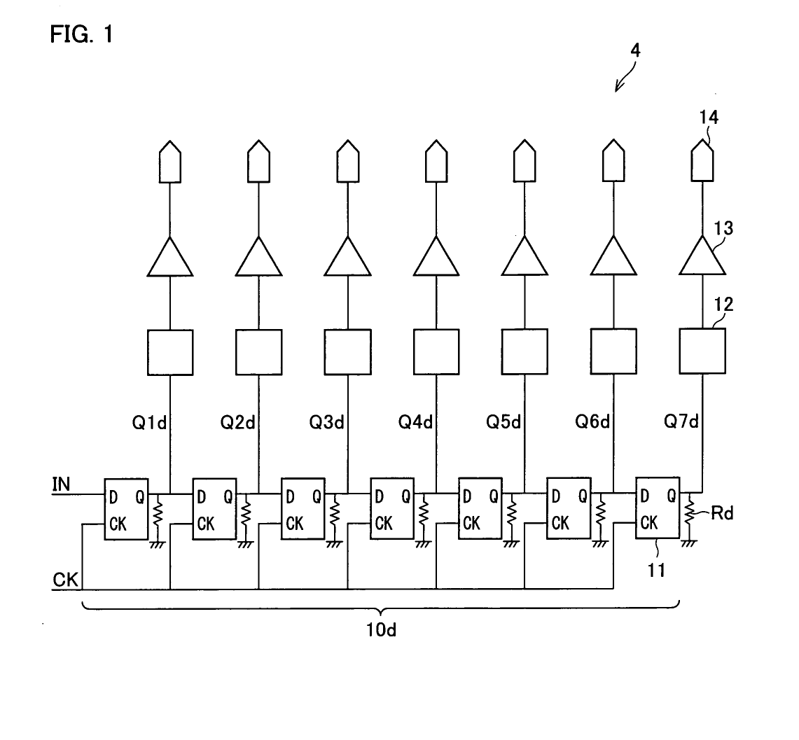

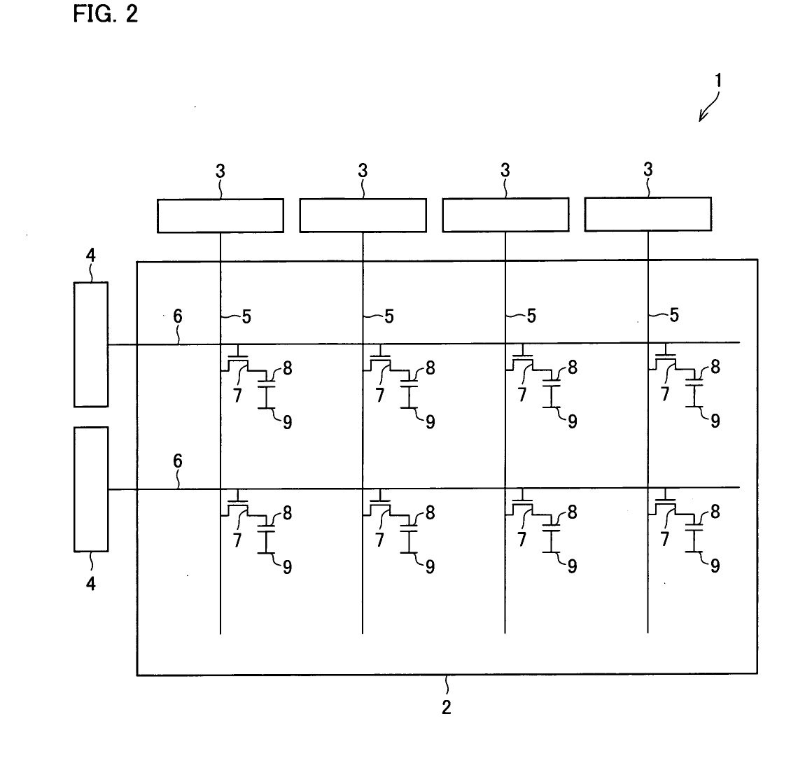

Embodiment 1 of the present invention is described below with reference to FIGS. 1 and 2.

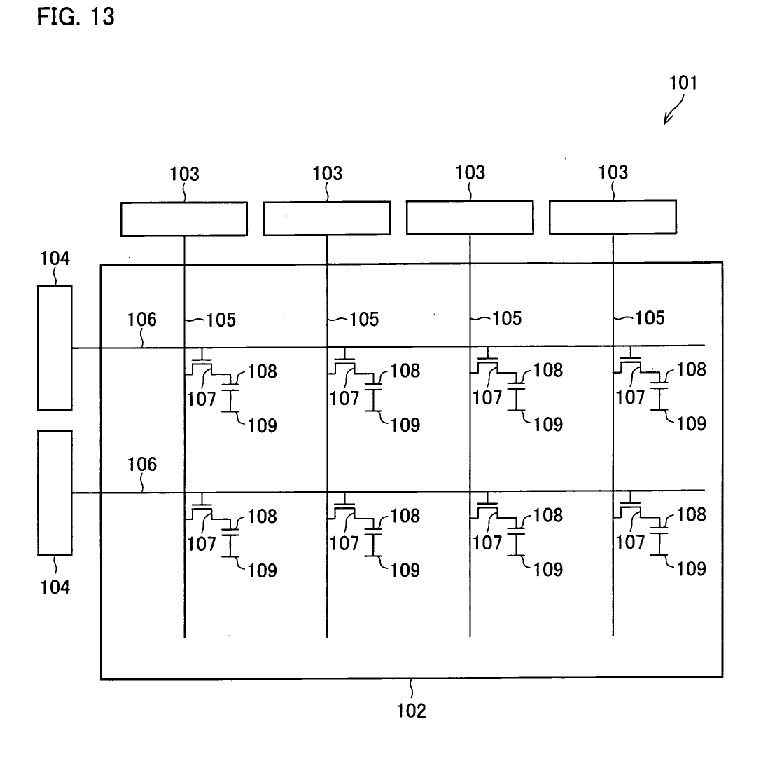

FIG. 2 is a schematic view showing the configuration of a TFT liquid crystal panel 1 according to the present embodiment. The TFT liquid crystal panel 1 includes a glass substrate 2, source drivers 3, and gate drivers 4. The glass substrate 2 has source lines 5 and gate lines 6 provided thereon. Provided at each point of intersection between the source lines 5 and the gate lines 6 is a TFT 7 and a pixel 8 that has an end connected to a counter electrode 9. It should be noted here that the glass substrate 2, source drivers 3, source lines 5, gate lines 6, TFTs 7, pixels 8, and counter electrodes 9 of the TFT liquid crystal panel 1 are substantially identical to the glass substrate 102, source drivers 103, source lines 105, gate lines 106, TFTs 107, pixels 108, and counter electrodes 109 of the TFT liquid crystal panel 101 of FIG. 13, respectively, and as such, are not detailed below.

In the present embodiment, each of the gate drivers 4 is configured as below so that the TFT liquid crystal panel 1 is made stronger in resistance to electromagnetic noise.

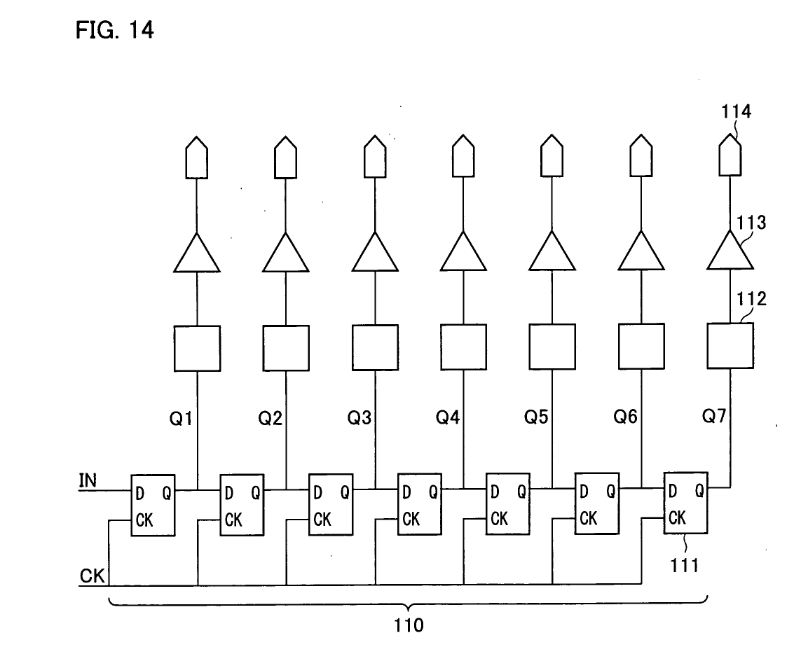

FIG. 1 is a circuit diagram showing the configuration of each of the gate drivers 4. Each of the gate drivers 4 includes a shift register 10d, seven level-shifter circuits 12, seven output buffers 13, and seven output terminals 14, and the shift register 10d includes seven D-FFs 11 connected in cascade. The D-FFs 11, level-shifter circuits 12, output buffers 13, and output terminals 14 are substantially identical to the D-FFs 111, level-shifter circuits 112, output buffers 113, and output terminals 114 of FIG. 14, respectively. It should be noted that the number of level-shifter circuits 12 or output buffers 113 is not limited to seven and can be set appropriately in accordance with the number of gate lines that are scanned.

The shift register 10d includes the seven D-FFs 11 connected in cascade, and an input signal IN of the gate driver 4 is inputted to a data input terminal D of the first D-FF 11. Further, an actuating clock CLK is inputted to the respective clock terminals CK of the D-FFs 11 of the shift register 10d, and signals Q1d to Q7d are outputted from the respective data output terminals Q of the D-FFs 11.

Furthermore, the shift register 10d has pull-down resistors Rd connected to the respective data output terminals Q of the D-FFs 11. More specifically, each of the pull-down resistors Rd has one end connected to the data output terminal Q of its corresponding D-FF 11 and the other end grounded.

This brings about an effect of canceling a change in level of the signals Q1d to Q7d of the D-FFs 11 toward High caused by external electromagnetic noise. Therefore, a gate line that is not supposed to carry out a display can be prevented from being accidentally turned on by noise that causes a change in level toward High and causing a display problem as a result.

The smaller the pull-down resistors Rd are in value of resistance, the higher the resistance to noise that causes a change in level toward High can be; at the same time, the lower the driving capacity of the shift register 10d to output High pulses becomes. Such degradation in driving capacity of the shift register 10d may result in disappearance of normally shifted High pulses when noise that causes a change in level toward Low is received. Further, the value of resistance of each of the pull-down resistors Rd is a value relative to the buffer capacity of its corresponding D-FF 11, and the buffer capacity of each of the D-FFs 11 requires different values depending on the size and operating speed of the circuit that is driven. Therefore, the value of resistance of each of the pull-down resistors Rd is set in consideration of assumed noise, the buffer capacity of its corresponding D-FF 11, and the like.

Further, although the present embodiment has the pull-down resistors Rd provided at the respective data output terminals Q of the D-FFs 11, noise resistance can still be improved in comparison with the conventional configuration by providing a single pull-down resistor Rd at the data output terminal Q of at least one of the D-FFs 11. Further, the D-FFs 11 may be of another type of flip-flop such as a JK type.

### Embodiment 2

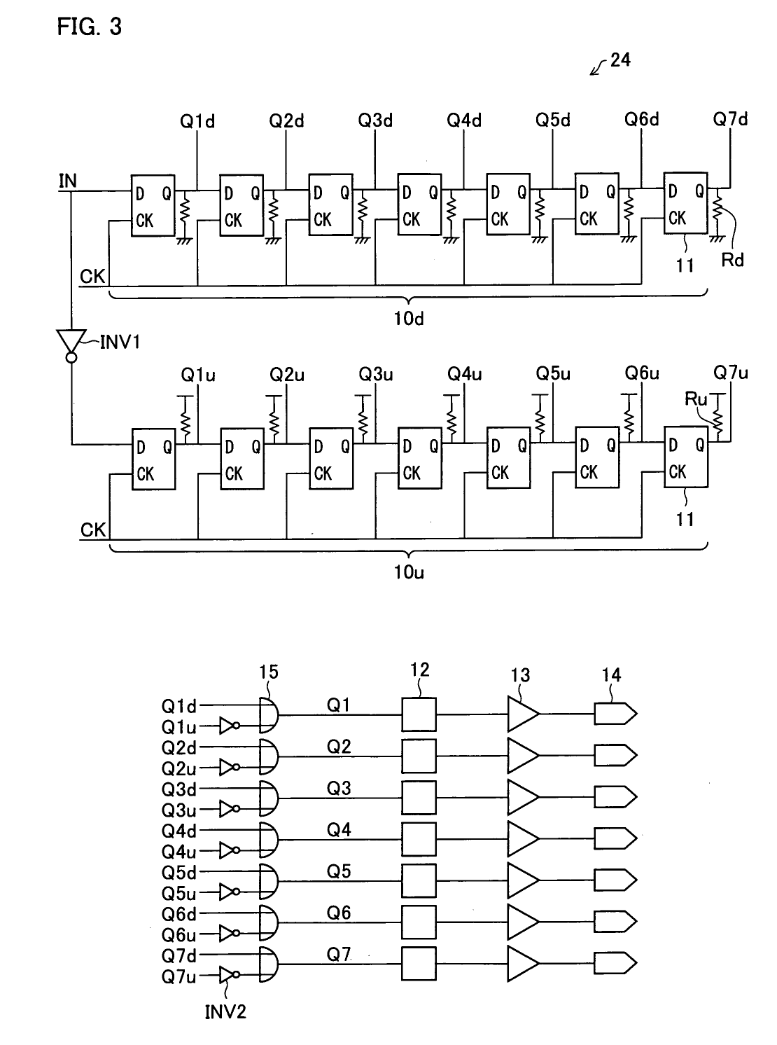

Embodiment 2 of the present invention is described below with reference to FIGS. 3 through 6. Although the gate drivers 4 according to Embodiment 1 have improved resistance to noise that causes a change in level toward High, the provision of the pull-down resistors Rd leads to degradation in resistance to noise that causes a change in level toward Low. In view of this, the present embodiment describes a configuration with improved resistance to noise that causes a change in level toward Low as well.

FIG. 3 is a circuit diagram showing the configuration of each gate driver 24 according to the present embodiment. Each gate driver 24 includes two shift registers 10d and 10u, seven level-shifter circuits 12, seven output buffers 13, seven output terminals 14, and seven OR circuits 15. That is, each gate driver 24 is configured by further providing the shift register 10u and the OR circuits 15 in such a gate driver 4 as shown in FIG. 1.

As with the shift register 10d, the shift register 10u includes seven D-FFs 11 connected in cascade, and an input signal IN of the gate driver 4 is inputted to a data input terminal D of the first D-FF 11 of the shift register 10u through an inverter INV1. Further, an actuating clock CLK is inputted to the respective clock terminals CK of the D-FFs 11 of the shift register 10u, and signals Q1u to Q7u are outputted from the respective data output terminals Q of the D-FFs 11.

Furthermore, the shift register 10u has pull-up resistors Ru connected to the respective data output terminals Q of the D-FFs 11. More specifically, each of the pull-up resistors Ru has one end connected to the data output terminal Q of its corresponding D-FF 11 and the other end to the power supply potential.

The signals Q1d to Q7d are outputted from the respective D-FFs 11 of the shift register 10d, and the signals Q1u to Q7u are outputted from the respective D-FFs 11 of the shift register 10u. Each of the signals Q1d to Q7d is inputted to one input terminal of its corresponding OR circuit 15. Meanwhile, each of the signals Q1u to Q7u is inputted to the other input terminal of its corresponding OR circuit 15 through an inverter INV1. Thus, each of the OR circuits 15 outputs a logical sum of a signal Qmd and an inverted version of a signal Qmu (where m is an integer of 1 to 7) to its corresponding level-shifter circuit 12 as a signal Qm (where m is an integer of 1 to 7). The signals Q1 to Q7 are subjected to level conversion in the respective level-shifter circuits 12 and then outputted from the output terminals 14 to the gate line through the output buffers 13, respectively.

As stated above, each gate driver 24 of the present embodiment includes a shift register 10d having pull-down resistors Rd provided at the respective data output terminals Q of the D-FFs 11 of the shift register 10d and a shift register 10u, having pull-up resistors Ru provided at the respective data output terminals Q of the D-FFs 11 of the shift register 10u, which shifts signals opposite in logical value to those which are shifted by the shift register 10d. The shift register 10d brings about an effect of canceling a change in level of the signals Q1d to Q7d of the D-FFs 11 toward High caused by external electromagnetic noise. Meanwhile, the shift register 10u brings about an effect of canceling a change in level of the signals Q1u to Q7u of the D-FFs 11 toward Low caused by external electromagnetic noise.

Furthermore, each of the OR circuits 15 receives a signal Qmd (where m is an integer of 1 to 7) from the shift register 10d and an inverted version of a signal Qmu (where m is an integer of 1 to 7), sent from the shift register 10u, and then outputs a logical sum of the signal Qmd and the inverted version of the signal Qmu as a signal Qm (where m is an integer of 1 to 7). Therefore, even when external noise causes either of the outputs of the shift registers 10d and 10u to disappear, the signals Q1 to Q7 do not disappear. Thus, each gate driver 4 has improved resistance not only to noise that causes a change in level toward High, but also to noise that causes a change in level toward Low.

The following explains the timing of the signals outputted from the shift registers 10d and 10u and the OR circuits 15.

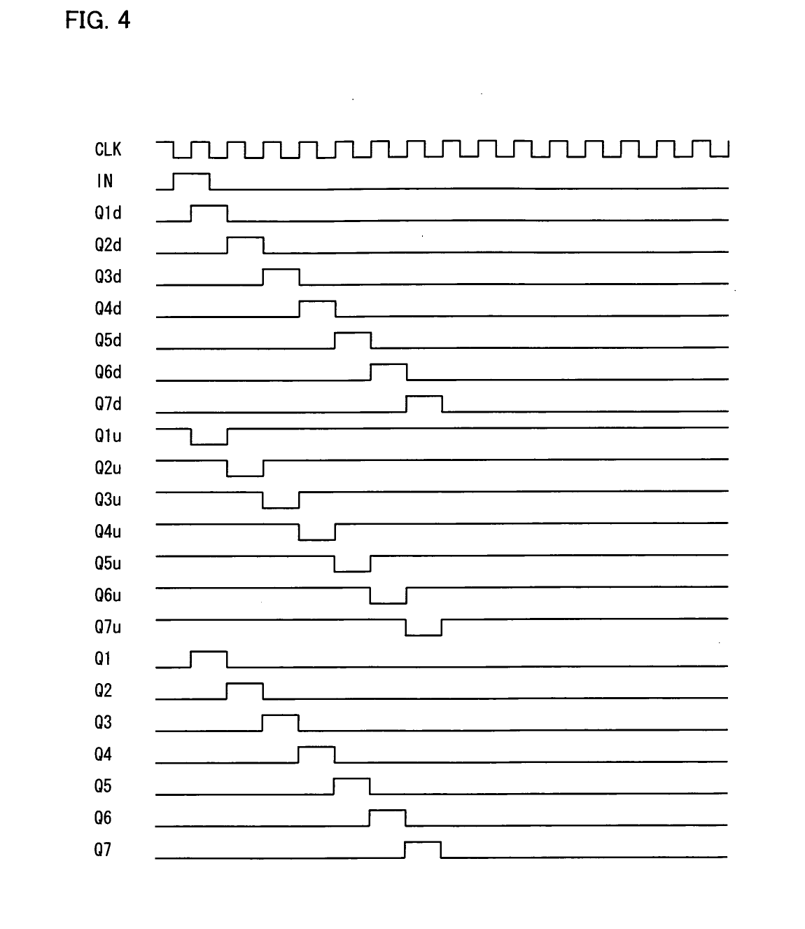

FIG. 4 is a timing chart showing the waveforms of the signals Q1d to Q7d, the signals Q1u and Q7u, and the signals Q1 to Q7 at normal times when no noise is being received. When the shift register 10d receives the input signal IN, the D-FFs 11 of the shift register 10d shift the input signal IN in synchronization with rising edges of the actuating clock CLK and output the signals Q1d to Q7d. Meanwhile, the D-FFs 11 of the shift register 10u shift an inverted version of the input signal IN in synchronization with the rising edges of the actuating clock CLK and output the signals Q1u to Q7u. Each of the OR circuits 15 receives a signal Qmd and an inverted version of a signal Qmu (where m is an integer of 1 to 7) and then outputs a signal Qm (where m is an integer of 1 to 7), that is, a logical sum of the signal Qmd and the inverted version of the signal Qmu.

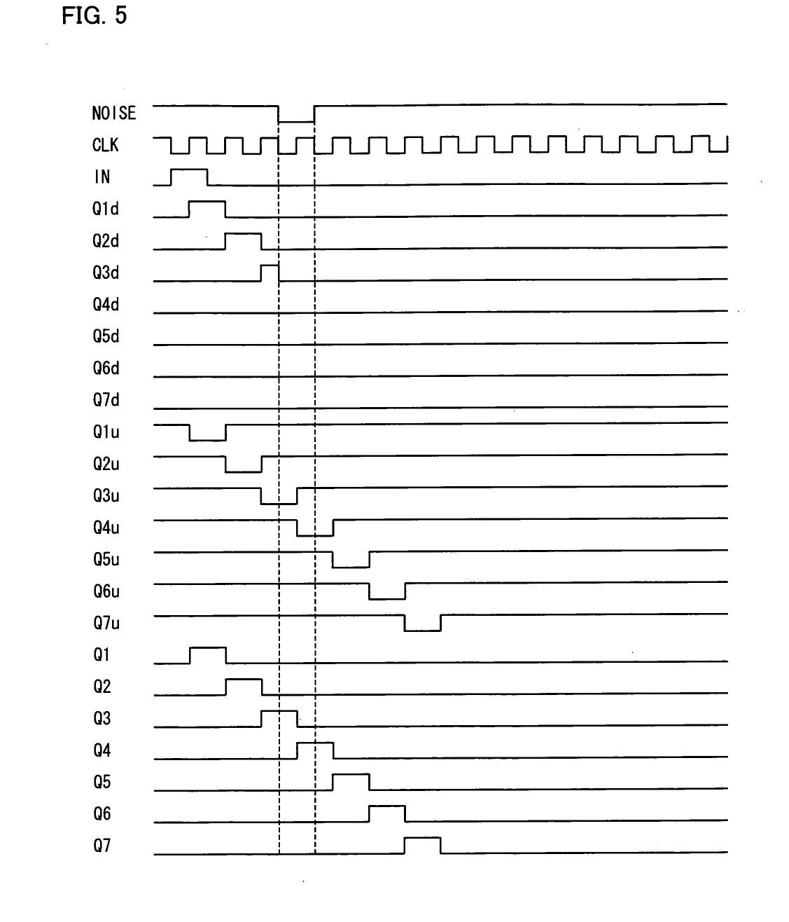

FIG. 5 is a timing chart showing the waveforms of the signals Q1d to Q7d, the signals Q1u and Q7u, and the signals Q1 to Q7 when noise that causes a change in level toward Low is received. In the shift register 10d, the noise causes the High pulse of the signal Q3d to dissipate, with the result that the signals Q4d to Q7d are not outputted, either. Meanwhile, in the shift register 10u, which has the pull-up resistors Ru provided at the respective data output terminals Q of the D-FFs 11, the signals Q1u to Q7u are unlikely to be influenced by noise that causes a change in level toward Low, with the result that the signal Q3u does not dissipate even at the time of occurrence of noise. Accordingly, without the influence of noise, the signals Q1u to Q7u are outputted in the same way as those which are outputted at normal times, and the inverted versions of the signals Q1u to Q7u are inputted to their respective OR circuits 15. Therefore, the signals Q1 to Q7 outputted from their respective OR circuits 15 are identical in waveform to those which are outputted at normal times.

On the other hand, when noise that causes a change in signal toward High is received and the shift register 10u stops shifting, the shift register 10d is unlikely to be influenced by noise that causes a change in signal toward High, with the result that the signals Q1d to Q7d from the shift register 10d do not dissipate. Therefore, the signals Q1 to Q7 outputted from their respective OR circuits 15 do not show the effect of noise.

As stated above, each gate driver 4 can output the same signals as those which are outputted at normal times, regardless of whether it receives noise that causes a change in signal toward Low or noise that causes a change in signal toward High. Therefore, a TFT liquid crystal panel including gate drivers 24 according to the present embodiment is unlikely to suffer from a display problem even when it receives external electromagnetic noise.

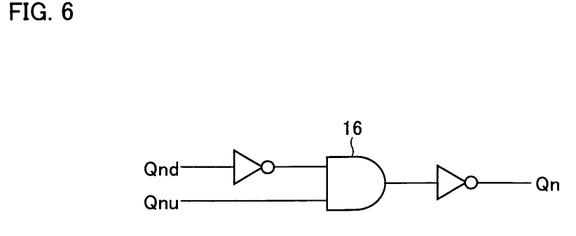

It should be noted that the circuits, provided in each gate driver 24, each of which outputs a logical sum of a signal Qmd (where m is an integer of 1 to 7) from the shift register 10d and an inverted version of a signal Qmu (where m is an integer of 1 to 7) from the shift register 10u are not limited to the OR circuits 15, and may be constituted by AND circuits instead. That is, as shown in FIG. 6, an inverted version of a signal Qmd and a signal Qmu may be inputted to an AND circuit 16, and an inverted version of a signal outputted from the AND circuit 16 may be outputted to the level-shifter circuit 12 as a signal Qm.

### Embodiment 3

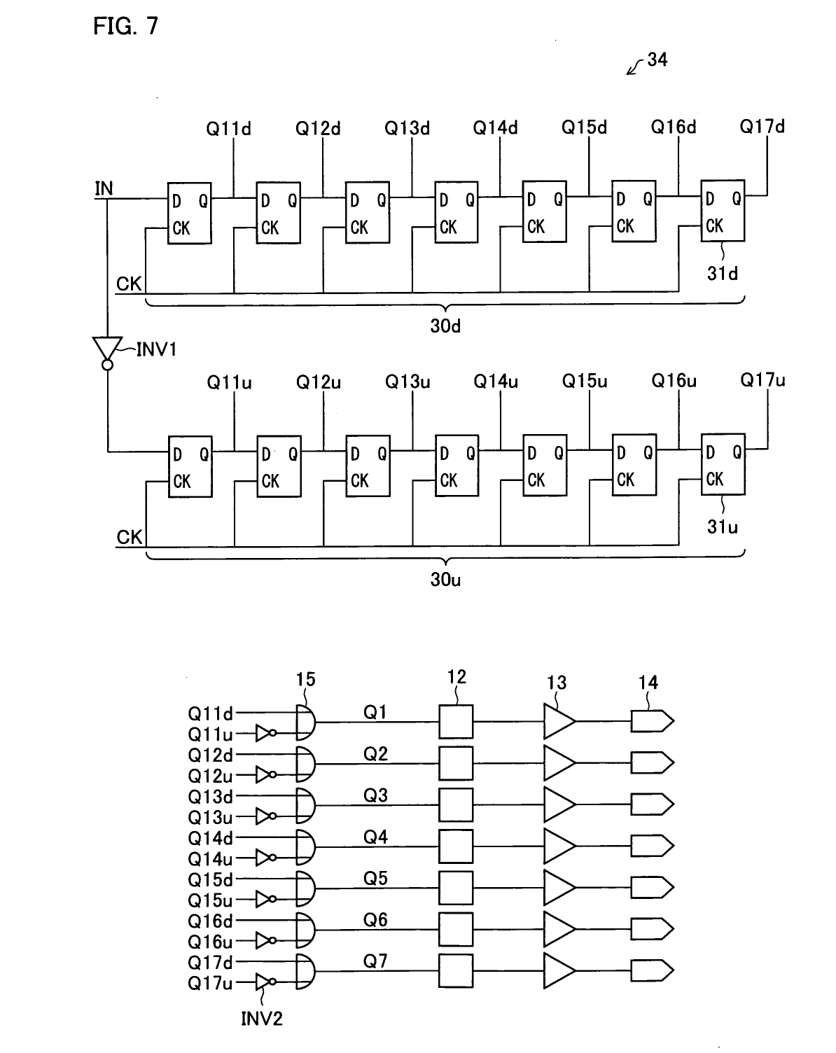

Embodiment 3 of the present invention is described below with reference to FIGS. 7 through 9. Embodiments and 2 have described a configuration having a pull-down or pull-up resistor provided between the data output terminal of each D-FF and the data input terminal of the next D-FF. This makes it possible to improve noise resistance between one D-FF and another; however, the influence of noise on the internal circuit of a D-FF may lead to a change in an output signal from the D-FF. In view of this, the present embodiment describes the configuration of a gate driver whose noise resistance has been improved by providing a pull-down resistor and a pull-up resistor inside of each D-FF.

FIG. 7 is a circuit diagram showing the configuration of each gate driver 34 according to the present embodiment. Each gate driver 34 is configured by replacing the shift registers 10d and 10u with shift registers 30d and 30u in such a gate driver 24 as shown in FIG. 3. The shift register 30d is configured by replacing the D-FFs 11 with D-FFs 31d without providing a pull-down resistor Rd between one D-FF and another in the shift register 10d of FIG. 3, and the D-FF 31d outputs their respective signals Q11d to Q17d. Further, the shift register 30u is configured by replacing the D-FFs 11 with D-FFs 31u without providing a pull-up resistor Ru between one D-FF and another in the shift register 10u of FIG. 3, and the D-FF 31u outputs their respective signals Q11u and Q17u. In FIG. 7, members identical to those in the gate driver 24 of FIG. 3 are given the same reference numerals, and as such, are not detailed.

Each of the D-FFs 31d and 31u contains both a pull-down resistor and a pull-up resistor. Each of the D-FFs 31d is configured to be stronger in resistance to noise that causes a change in signal toward High. Meanwhile, each of the D-FFs 31u is configured to be stronger in resistance to noise that causes a change in signal toward Low.

Therefore, the signal Q11d to Q17d are unlikely to be influenced by noise that causes a change toward High, and the signal Q11u to Q17u are unlikely to be influenced by noise that causes a change toward Low. Furthermore, each of the OR circuits 15 receives a signal Qnd (where n is an integer of 11 to 17) and an inverted version of a signal Qnu (where n is an integer of 11 to 17) and then outputs a logical sum of the signal Qnd and the inverted version of the signal Qnu as a signal Qm (where m is an integer of 1 to 7). Therefore, even when external noise causes either of the outputs of the shift registers 30d and 30u to disappear, the signals Q1 to Q7 do not disappear.

The following details the configuration of each of the D-FFs 31d and 31u.

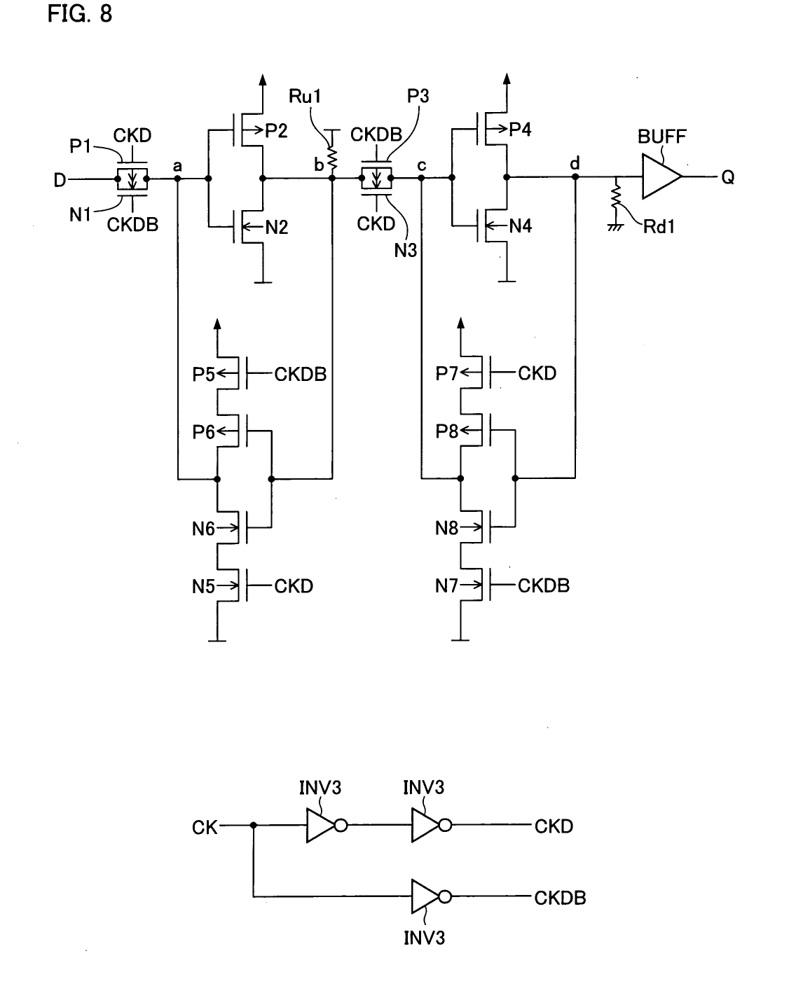

FIG. 8 is a circuit diagram detailing the configuration of each of the D-FFs 31d. Each of the D-FFs 31d includes eight P-channel MOS transistors P1 to P8 (hereinafter referred to as “transistors P1 to P8”), eight N-channel MOS transistors N1 to N8 (hereinafter referred to as “transistors N1 to N8”), three inverters INV3, and a buffer BUFF. An actuating clock CLK inputted to a clock input terminal CK divides into a signal CKD through two of the inverters INV3 and a signal CKDB through the remaining one of the inverters INV3.

The two transistors P1 and N1 constitute a transfer gate (first transfer gate) that receives a signal from a data input terminal D. The signal CKD is inputted to a gate of the transistor P1, and the signal CKDB is inputted to a gate of the transistor N1.

The two transistors P2 and N2 constitute an inverter (first inverter). Further, the four transistors P5, P6, N6, and N5 are connected in series. Specifically, the transistor P5 has its source connected to the power supply potential and its drain to a source of the transistor P6. The transistor P6 has its drain connected to a drain of the transistor N6, and the transistor N6 has its source connected to a drain of the transistor N5, which has its source grounded. The signal CKD is inputted to a gate of the transistor P5, and the signal CKDB is inputted to a gate of the transistor N5.

The first transfer gate, which is constituted by the transistors P1 and N1, sends its output to the first inverter, which is constituted by the transistors P2 and N2, the drain of the transistor P6, and the drain of the transistor N6.

The two transistors P3 and N3 constitute a transfer gate (second transfer gate), and a drain of the transistor P2, a drain of the transistor N2, a gate of the transistor P6, a gate of the transistor N6, and an input of the second transfer gate are connected to one another. The signal CKDB is inputted to a gate of the transistor P3, and the signal CKD is inputted to a gate of the transistor N3.

The two transistors P4 and N4 constitute an inverter (second inverter). Further, the four transistors P7, P8, N8, and N7 are connected in series. Specifically, the transistor P7 has its source connected to the power supply potential and its drain to a source of the transistor P8. The transistor P8 has its drain connected to a drain of the transistor N8, and the transistor N8 has its source connected to a drain of the transistor N7, which has its source grounded. The signal CKDB is inputted to a gate of the transistor P7, and the signal CKD is inputted to a gate of the transistor N7.

The second transfer gate, which is constituted by the transistors P3 and N3, sends its output to the second inverter, which is constituted by the transistors P4 and N4, the drain of the transistor P8, and the drain of the transistor N8.

The buffer BUFF has its input terminal connected to a drain of the transistor P4, a drain of the transistor N4, a gate of the transistor P8, and a gate of the transistor N8. The buffer BUFF has its output terminal serving as the data output terminal Q of the D-FF 31d.

Let it be assumed here that Point a is a connection point between the first transfer gate, which is constituted by the transistors P1 and N1, and the first inverter, which is constituted by the transistors P2 and N2. Let it be also assumed that Point b is a connection point between the inverter constituted by the transistors P2 and N2 and the transfer gate constituted by the transistors P3 and N3. Let it be also assumed that Point c is a connection point between the transfer gate constituted by the transistors P3 and N3 and the inverter constituted by the transistors P4 and N4. Let it be also assumed that Point d is a connection point between the inverter constituted by the transistors P4 and N4 and the buffer BUFF.

The D-FF 31d has a pull-up resistor Ru1 further provided at Point b and a pull-down resistor Rd1 at Point b. Thus, the D-FF 31d is unlikely to change in level of an output signal from the buffer BUFF, i.e., an output signal from the D-FF 31d even in response to noise that causes a change in level toward High. That is, the pull-up resistor Ru1 and the pull-down resistor Rd 1 bring about improvement in internal resistance of the D-FF 31d to noise that causes a change in level toward High.

It should be noted that the internal resistance of the D-FF 31d to noise that causes a change in level toward High can be improved in the same way as above by either increasing the gate widths or shortening the gate lengths of the transistors P2 and N4, instead of providing the pull-up resistor Ru1 and the pull-down resistor Rd1, to enhance the driving capacity of the transistors P2 and N4.

Alternatively, the internal resistance of the D-FF 31d to noise that causes a change in level toward High can be improved similarly by providing the pull-down resistor Rd 1 at Point a and the pull-up resistor Ru1 at Point c.

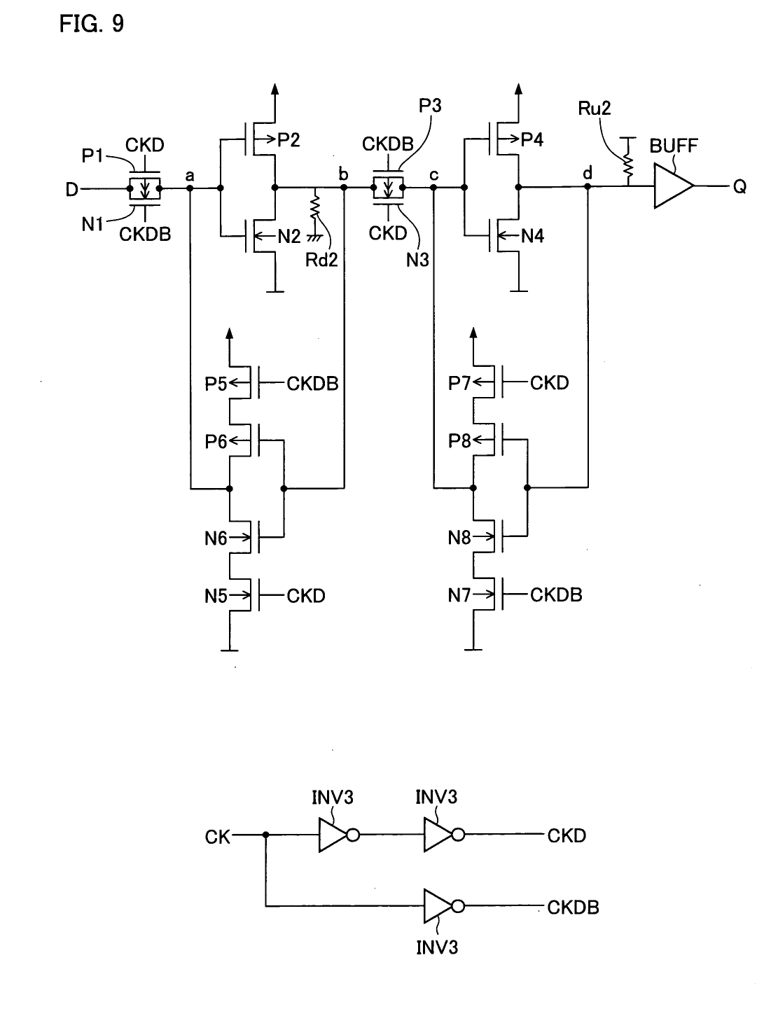

FIG. 9 is a circuit diagram detailing the configuration of each of the D-FFs 31u. Each of the D-FFs 31u is configured by replacing the pull-up resistor Ru1 with a pull-down resistor Rd2 at Point b and the pull-down resistor Rd 1 with a pull-up resistor Ru2 at Point d in such a D-FF 31d as shown in FIG. 8. Thus, as opposed to the D-FF 31d, the D-FF 31u is unlikely to change in level of an output signal from the buffer BUFF, i.e., an output signal from the D-FF 31u even in response to noise that causes a change in level toward Low. That is, the pull-up resistor Ru2 and the pull-down resistor Rd2 can bring about improvement in internal resistance of the D-FF 31u to noise that causes a change in level toward Low.

It should be noted that the internal resistance of the D-FF 31u to noise that causes a change in level toward Low can be improved in the same way as above by either increasing the gate widths or shortening the gate lengths of the transistors N2 and P4, instead of providing the pull-up resistor Ru2 and the pull-down resistor Rd2, to enhance the driving capacity of the transistors N2 and P4.

Alternatively, the internal resistance of the D-FF 31u to noise that causes a change in level toward Low can be improved similarly by providing the pull-down resistor Ru2 at Point a and the pull-up resistor Rd2 at Point c.

Alternatively, each gate driver may be configured by replacing the D-FFs 11 with D-FF 31d in such a gate driver 4 as shown in FIG. 1 and, in this case, it may also be configured without providing a pull-down resistor Rd. In either configuration, the resistance to noise that causes a change in level toward High can be improved in comparison with the conventional configuration.

### Embodiment 4

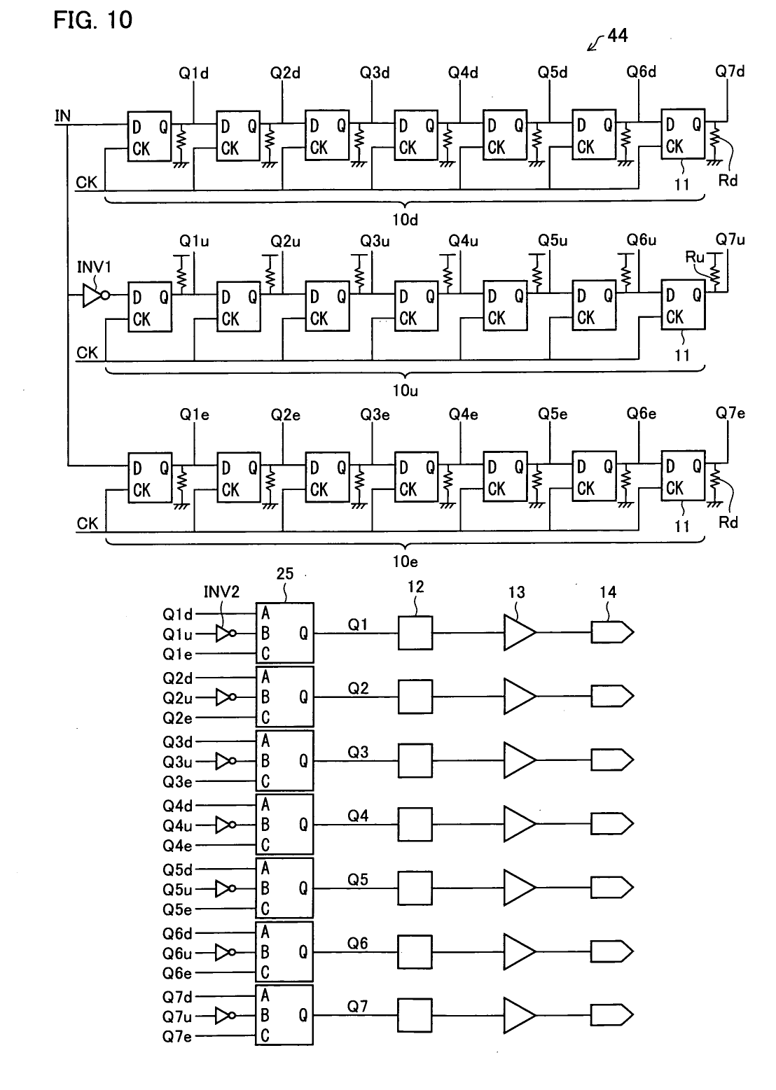

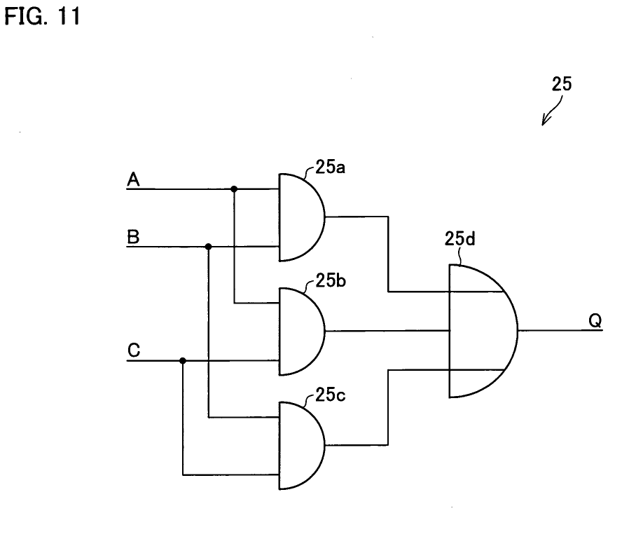

Embodiment 4 of the present invention is described below with reference to FIGS. 10 and 11.

FIG. 10 is a circuit diagram showing the configuration of each gate driver 44 according to the present embodiment. Each gate driver 44 is configured by further providing a shift register 10e and replacing the OR circuits 15 with majority circuits 25 in such a gate driver 24 as shown in FIG. 3.

As with the shift register 10d, the shift register 10e includes seven D-FFs 11 connected in cascade, and an input signal IN of the gate driver 44 is inputted to a data input terminal D of the first D-FF 11 of the shift register 10e. Further, an actuating clock CLK is inputted to the respective clock terminals CK of the D-FFs 11 of the shift register 10e, and signals Q1e to Q7e are outputted from the respective data output terminals Q of the D-FFs 11.

Furthermore, as with the shift register 10d, the shift register 10e has pull-down resistors Rd connected to the respective data output terminals Q of the D-FFs 11. More specifically, each of the pull-down resistors Rd has one end connected to the data output terminal Q of its corresponding D-FF 11 and the other end grounded.

Each of the majority circuits 25 has three input terminals A to C and an output terminal Q. If two or all of the input terminals A to C are High, the output becomes High; and if two or all of the input terminals A to C are Low, the output becomes Low. Each of the majority circuits 25 receives a signal Qmd (where m is an integer of 1 to 7) from the shift register 10d at its input terminal A, an inverted version of a signal Qmu, sent from the shift register 10u, at its input terminal B, and a signal Qme from the shift register 10e at its input terminal C, and then outputs, as a signal Qm (where m is an integer of 1 to 7), two or all of these input signals that are identical in waveform.

Thus, while no external noise is being received, the signal Qmd, the signal Qmu, and the signal Qme are identical in waveform. It should be noted here that even when noise causes any one of the shift registers 10d, 10u, and 10e to malfunction, the majority circuits 25 receives signals a majority of which are normal in waveform, the majority circuits 25 output the same signals Qm as those which are outputted while no noise is being received. Thus, the gate driver 44 has improved resistance to noise.

It is desirable that the shift register 10d and the shift register 10e be located in distant places on the integrated circuit and use separate power supplies and separate GND wires from each other. This makes it is possible to reduce the risk that both of the shift registers 10d and 10e malfunction when the gate driver 44 receives noise that causes a change in level toward Low.

FIG. 11 is a circuit diagram detailing the configuration of each of the majority circuits 25. Each of the majority circuits 25 includes: three AND circuits 25a, 25b, and 25c; and an OR circuit 25d. The AND circuit 25a and the AND circuit 25b receive a signal from the input terminal A. The AND circuit 25b and the AND circuit 25c receive a signal from the input terminal B. The AND circuit 25b and the AND circuit 25c receive a signal from the input terminal C. The OR circuit 25d receives the respective outputs from the AND circuits 25a, 25b, and 25c. The OR circuit 25d has its output terminal serving as the output terminal Q of the majority circuit 25.

It should be noted that the configuration of FIG. 11 is merely an example of a majority circuit and another publicly known majority circuit can be applied. Alternatively, each gate driver 44 may be configured by replacing the majority circuits 25 with OR circuits each of which outputs a logical sum of a signal Qmd, a signal Qmu, and a signal Qme (where m is an integer of 1 to 7).

Further, although the number of shift registers in the present embodiment is three, such a configuration is possible that five shift registers or a larger odd number of shift registers are provided and a majority is taken among signals from each of the shift registers.

### Overview of the Embodiments

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be applied suitably to display devices such as liquid crystal displays.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A scan signal line driver circuit comprising a first shift register having M (where M is an integer of 2 or greater) flip-flops connected in cascade, the first shift register receiving an input signal from outside, transferring the input signal to the subsequent flip-flops sequentially in synchronization with a clock signal, outputting first shift pulses through respective data output terminals of the flip-flops, thereby driving a scan signal line of a display screen,
at least one of the flip-flops having its data output terminal connected to a pull-down resistor.

2. The scan signal line driver circuit as set forth in claim 1, further comprising:
a second shift register having M flip-flops connected in cascade; and
M logic circuits, wherein:
the second shift register transfers an inverted version of the input signal to the subsequent flip-flops sequentially in synchronization with the clock signal and outputs second shift pulses through respective data output terminals of the flip-flops;
at least one of the flip-flops of the second shift register having its data output terminal connected to a pull-up resistor;
each of the logic circuits outputs a logical sum of a first shift pulse from the Nth (where N is an integer of 1 to M) flip-flop of the first shift register and an inverted version of a second shift pulse from the Nth flip-flop of the second shift register as a third shift pulse; and
the third shift pulses allow the scan signal line to be driven.

3. A scan signal line driver circuit comprising a first shift register having M (where M is an integer of 2 or greater) flip-flops connected in cascade, the first shift register receiving an input signal from outside, transferring the input signal to the subsequent flip-flops sequentially in synchronization with a clock signal, outputting first shift pulses through respective data output terminals of the flip-flops, thereby driving a scan signal line of a display screen,
at least one of the flip-flops including a first transfer gate constituting a data input terminal of the at least one flip-flop, a first inverter, a second transfer gate, a second inverter, and a first buffer circuit constituting a data output terminal of the at least one flip-flop, the data input terminal, the first transfer gate, the first inverter, the second transfer gate, the second inverter, and the first buffer circuit being connected in this order,
a first pull-up resistor being provided at a first connection point between the first inverter and the second transfer gate,
a first pull-down resistor being provided at a second connection point between the second inverter and the first buffer circuit.

4. The scan signal line driver circuit as set forth in claim 3, wherein:
the first pull-up resistor is provided at a third connection point between the second transfer gate and the second inverter instead of being provided at the first connection point; and
the first pull-down resistor is provided at a fourth connection point between the first transfer gate and the first inverter instead of being provided at the second connection point.

5. The scan signal line driver circuit as set forth in claim 3, wherein:
the first inverter is constituted by a first transistor that outputs a high-level signal and a second transistor that outputs a low-level signal;
the second inverter is constituted by a third transistor that outputs a high-level signal and a fourth transistor that outputs a low-level signal; and
instead of providing the first pull-up resistor and the first pull-down resistor, the first transistor is set higher in driving capacity than the second transistor and the fourth transistor is set higher in driving capacity than the third transistor.

6. The scan signal line driver circuit as set forth in claim 3, further comprising:
a second shift register having M flip-flops connected in cascade; and
M logic circuits, wherein:
the second shift register transfers an inverted version of the input signal to the subsequent flip-flops sequentially in synchronization with the clock signal and outputs second shift pulses through respective data output terminals of the flip-flops;
at least one of the flip-flops of the second shift register includes a third transfer gate constituting a data input terminal of the at least one flip-flop, a third inverter, a fourth transfer gate, a fourth inverter, and a second buffer circuit constituting a data output terminal of the at least one flip-flop, the data input terminal, the third transfer gate, the third inverter, the fourth transfer gate, the fourth inverter, and the second buffer circuit being connected in this order;
a second pull-down resistor is provided at a fifth connection point between the third inverter and the fourth transfer gate,
a second pull-up resistor is provided at a sixth connection point between the fourth inverter and the second buffer circuit;
each of the logic circuits outputs a logical sum of a first shift pulse from the Nth (where N is an integer of 1 to M) flip-flop of the first shift register and an inverted version of a second shift pulse from the Nth flip-flop of the second shift register as a third shift pulse; and
the third shift pulses allow the scan signal line to be driven.

7. The scan signal line driver circuit as set forth in claim 6, wherein:
the second pull-down resistor is provided at a seventh connection point between the fourth transfer gate and the fourth inverter instead of being provided at the fifth connection point; and
the second pull-up resistor is provided at an eighth connection point between the third transfer gate and the third inverter instead of being provided at the sixth connection point.

8. The scan signal line driver circuit as set forth in claim 6, wherein:
the third inverter is constituted by a fifth transistor that outputs a high-level signal and a sixth transistor that outputs a low-level signal;
the fourth inverter is constituted by a seventh transistor that outputs a high-level signal and an eighth transistor that outputs a low-level signal; and
instead of providing the second pull-up resistor and the second pull-down resistor, the sixth transistor is set higher in driving capacity than the fifth transistor and the seventh transistor is set higher in driving capacity than the eighth transistor.

9. A scan signal line driver circuit comprising: at least one first shift register having M (where M is an integer of 2 or greater) flip-flops connected in cascade;
at least one second shift register having M flip-flops connected in cascade; and
M majority circuits,
the total sum of the number of the at least one first shift register and the number of the at least one second shift register being three or a larger odd number,
the at least one first shift register receiving an input signal from outside, transferring the input signal to the subsequent flip-flops sequentially in synchronization with a clock signal, outputting first shift pulses through respective data output terminals of the flip-flops of the at least one first shift register,
at least one of the flip-flops of the at least one first shift register having its data output terminal connected to a pull-down resistor,
the at least one second shift register transferring an inverted version of the input signal to the subsequent flip-flops sequentially in synchronization with the clock signal and outputting second shift pulses through respective data output terminals of the flip-flops of the at least one second shift register,
at least one of the flip-flops of the at least one second shift register having its data output terminal connected to a pull-up resistor,
each of the majority circuits receiving a first shift pulse from the Nth (where N is an integer of 1 to M) flip-flop of the at least one first shift register and an inverted version of a second shift pulse from the Nth flip-flop of the at least one second shift register,
the majority circuit choosing pulses that form a majority among the pulses thus received and outputting, as a third shift pulse, the pulses thus chosen,
the third shift pulses allowing a scan signal line of a display screen to be driven.

10. The scan signal line driver circuit as set forth in claim 9, wherein when the at least one first or second shift register comprises a plurality of first or second shift registers, the plurality of first or second shift registers are not located close to each other and do not share a power supply wire or a GND wire with each other.

11. A display device comprising a scan signal line driver circuit as set forth in any one of claims 1.
